(19) United States
(12) Patent Application Publication
(10) Pub. No.: US 2016/0335841 A1
(43) Pub. Date: Nov. 17, 2016

(54) GAMES AND GAMING MACHINES HAVING OUTCOME NORMALIZATION FEATURE

(71) Applicant: AGS, LLC, Las Vegas, NV (US)

(72) Inventors: Arthur Lee, Las Vegas, NV (US); David Wright, Las Vegas, NV (US)

(21) Appl. No.: 14/708,562

(22) Filed: May 11, 2015

(51) Int. Cl. G07F 17/32; G07F 17/34

(52) U.S. Cl. CPC G07F 17/3213; G07F 17/34

(57) ABSTRACT

Games and gaming machines are provided with an outcome normalization feature. In a method of presenting and playing a game, a game outcome is selected. If the outcome has been selected a minimum number of times since the last time the outcome was presented, that game outcome is used as the outcome of the game and is presented to the player. Otherwise, another game outcome is selected and the process is repeated. A counter or tally may be utilized to tracking the number of times a particular outcome has been selected, wherein the counter is incremented when the outcome is selected and is reset to a base value when the outcome is presented.

### FIELD OF THE INVENTION

The present invention relates to methods of presenting and playing games and gaming machines configured to present games.

### BACKGROUND OF THE INVENTION

Originally slot machines had rotating physical reels. A number of symbols were positioned on the reels and the reels were spun and the outcome was dependent upon the stopping position of the reels.

Today's gaming machines determine the outcome of a game based upon one or more random number generators. As one common method of determining the outcome of a slot type game, a random number is selected from a range of numbers. That selected random number is compared to a table which references the range of numbers to particular game outcomes. The game outcome corresponding to the selected random number is then displayed to the player, such as graphically via a video display or by stopping electronically controlled reels at positions which cause them to display the selected outcome.

One hurdle in designing gaming machines such as slot machines is creating a machine which is both exciting to the player and profitable to the casino. In order for the game to be exciting to the player, the game must return a relatively high amount of the wagers placed at the machine and preferably offer at least some opportunity for relatively high awards. In order for the game to be profitable to the casino, the game must hold back some part of the wagers which are placed by the players.

This balance was difficult to strike with old slot machines where these factors were primarily determined by the symbols which could be printed on each reel and the number of reel positions was relatively small. An advantage of new electronically controlled machines as described above is that large sets of winning and losing outcomes can be defined, thus permitting greater control over the machines.

Still, however, in the current state of the art there is still undesirable volatility in the game results. A new game and gaming machine is desired.

### SUMMARY OF THE INVENTION

Embodiments of the invention comprise an outcome normalization feature and games, gaming machines and gaming systems utilizing the normalization feature.

In accordance with one embodiment of the invention, in a method of playing and presenting a game, a game outcome is selected. It is determined whether the game outcome has been selected a predetermined minimum number of times since the last time the game outcome was presented. If so, then the game outcome is utilized as the outcome of the game and is presented to the player. If not, another game outcome is selected and the process is repeated.

In one embodiment, a counter or tally is provided relative to each game outcome. A value of the counter for a particular game outcome is incremented each time the game outcome is selected. If the value of the game outcome reaches the minimum value, the game outcome is presented and the counter value for that game outcome is reset to a base or starting value, such as zero.

The normalization feature may be applied to a wide variety of games, including wagering games. Such games may include, but are not limited to slot and card games.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine in accordance with one embodiment of the invention; and

FIG. 2 is a flow diagram which illustrates a method of presenting a game in accordance with an embodiment of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise a game outcome normalization feature, methods of playing and presenting games including the normalization feature, and gaming machines, devices and systems which implement the normalization feature.

Gaming machines or gaming devices in accordance with the invention may have various configurations. Such a gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more game servers, one or more table games, kiosks, accounting systems or servers, progressive systems or servers, player tracking systems or servers or the like.

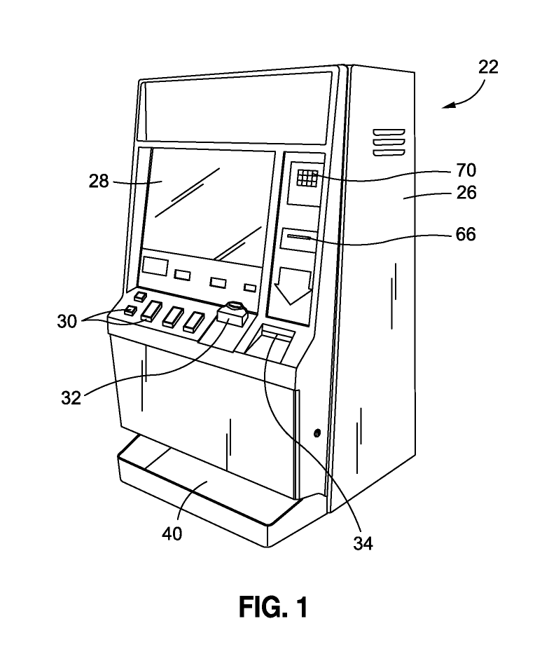

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

While the display devices may comprise one or more video displays, in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising one or more slot symbols, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting slot symbols, cards or other game symbols, game outcomes and/or otherwise presenting the game in a random fashion (e.g. whereby the game is presented in a manner in which the player cannot control the outcome).

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 28. The controller may accept input from a player of game inputs, such as a request to spin reels or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code, game data or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, instead of comprising a “casino”-style gaming machine, it is possible for a game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

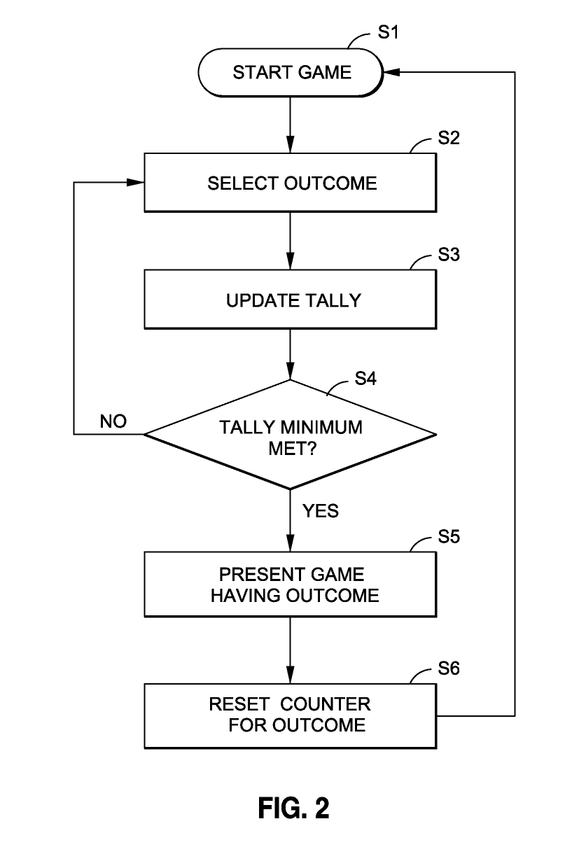

FIG. 2 is a flow diagram of a method of presenting a game in accordance with one embodiment of the invention, such as via a gaming machine as described above. As illustrated, in a first step S1, a game is started. In an embodiment where the game is a wager-based game, initiation of the game may comprise a player placing a wager. As indicated above, relative to a casino gaming machine, a player may associate monies or monetary value (or points, credits or the like) with the gaming machine. A player may place a wager using those monies, credits or the like, such as by making a wager input. Upon making a wager, if required, the game may start automatically or in response to a “start” input from the player.

In a step S2 of the invention, a game outcome is selected. The game outcome is preferably selected from a set of outcomes, such as a set of all possible game outcomes. As indicated below, such a selection may be accomplished via a random number generator, such as implemented via a processor of a gaming machine. However, the game outcome might be selected in other manners, including via one or more remote devices (such as a remote game server or the like).

In entertainment and wagering game implementations, some but not all of the outcomes may be designed as winning (with the remainder being losing outcomes). Winning outcomes may have associated awards, such as points, money, monetary value credit, prizes or the like. A pay table may define the winning and losing outcomes and associated wards.

The selected game outcome might be represented, for example, by a numerical value, code, or other data. In a preferred embodiment, the game outcome is randomly selected, such as via use of one or more random number generators.

In one embodiment, outcome tallies are provided relative to one or more game outcomes, such as all possible outcomes. These game tallies may comprise counters or other data for tracking game outcomes. In one embodiment, when the game is started, the game tallies or counters for the game outcomes may be set to a base or starting value. The base or starting value might comprise zero (0). However, the base or starting value might be other values, such as one (1) or the like.

In a step S3, the game tally or counter for the selected game outcome is updated or incremented. For example, if the game tallies or counters are incremented by a value of one (1), the value of the game tally or counter for the selected outcome would be increased by one (1).

In a step S4, it is determined if the value of the game tally or counter for the selected outcome has met a minimum value. The minimum value may be the same for each game outcome or it might differ for different outcomes.

If the value of the game tally or counter for the selected game outcome has met the required minimum value, then in a step S5, the game is presented having the selected game outcome. For example, this step may comprise displaying game data representing the selected game outcome. In a slot-type game, this may comprise displaying game symbols, such as via graphical representations of slot reels or by stopping physical reels at positions corresponding to those symbols. Of course, the game data might comprise images of cards, dice, a roulette wheel or other information, depending upon the particular game.

In a step S6, the counter or tally for a presented game outcome is then reset, preferably back to its base or starting value.

If in step S4 the tally or counter for the game outcome did not meet the minimum, then the process of selecting a game outcome is repeated at step S2.

One example of the present invention will now be described.

In this example, the game is a coin flip game in which the outcome of the game may be Heads or Tails. Preferably, when the game is initiated, a counter for the “Heads” outcome is set to zero (0) and the counter for the “Tails” outcome is set to zero (0).

As illustrated in TABLE A below, the game is started and the first game outcome is selected. In this case, the selected outcome was Heads. The counter for Heads is incremented from zero (0) to one (1). In this case, a minimum value of three (3) is required for the game outcome to be presented, so this outcome is not presented.

TABLE A
Selected Outcome 1
HEADS
Tallies Before

| | |
|---|---|
| HEADS | 0 |
| TAILS | 0 |

Tallies After

| | |
|---|---|
| HEADS | 1 |
| TAILS | 0 |
| Result: | Pick Again |

The process repeats and another game outcome is selected, as illustrated in TABLE B. In this case, the selected outcome was Tails. The counter for Tails is incremented from zero (0) to one (1). Again, because the minimum counter value of three (3) has not been met, so that game outcome is not presented.

TABLE B
Selected Outcome 2
TAILS
Tallies Before

| | |
|---|---|
| HEADS | 1 |
| TAILS | 0 |

Tallies After

| | |
|---|---|
| HEADS | 1 |
| TAILS | 1 |
| Result: | Pick Again |

The process continues as indicated in TABLES C-E:

TABLE C
Selected Outcome 3
TAILS
Tallies Before

| | |
|---|---|
| HEADS | 1 |
| TAILS | 1 |

Tallies After

| | |
|---|---|
| HEADS | 1 |
| TAILS | 2 |
| Result: | Pick Again |

TABLE D
Selected Outcome 4
HEADS
Tallies Before

| | |
|---|---|
| HEADS | 1 |
| TAILS | 2 |

Tallies After

| | |
|---|---|
| HEADS | 2 |
| TAILS | 2 |
| Result: | Pick Again |

TABLE E
Selected Outcome 5
HEADS
Tallies Before

| | |
|---|---|
| HEADS | 2 |
| TAILS | 2 |

Tallies After

| | |
|---|---|
| HEADS | 3 |
| TAILS | 2 |
| Result: | Present Outcome: HEADS |

As illustrated in TABLE E, the fifth selected outcome is Heads. The counter for the Heads outcome is incremented. Because the counter has reached a value the minimum value of three (3), the Heads game outcome is presented as the result of the game.

Thereafter, the counter for the Heads outcome is reset to its starting or base value of zero (0). On the other hand, the counter for the Tails outcome remains at two (2). Thus, if in the next game the first selected game outcome is Tails, the minimum required counter value will have been met and the Tails outcome will be immediately presented as the result of the game.

It will be appreciated that the minimum game tally or counter value may be different for different outcomes. For example, the minimum tally value may be one (1) for one game outcome and might be twenty (20) for another game outcome. Further, the minimum value for some outcomes might be zero (0)—e.g. the outcome may be presented automatically when it is selected. For example, in a wagering game having winning and losing outcomes, if a losing outcome is selected it may automatically be presented. On the other hand, one or more winning outcomes may be required to meet a minimum number of selections (e.g. more than one) before the outcome is presented, thus “normalizing” the presentation of winning outcomes.

Further, the minimum counter or tally value requirement may be applied to games where the probability of selecting different game outcomes may vary. For example, in some games the probability that a particular game outcome may be randomly selected may vary. As one example, a first winning outcome having a low payout value may have a higher probability of being selected than a second winning outcome having a higher payout value.

In accordance with the present invention, the normalization feature may be applied to such games. Set forth in Table F is an example of a game having four game outcomes, where the probability of selecting each outcome varies.

TABLE F

| Options | Weights | Chance | Cycle |
|---|---|---|---|
| Outcome 1 | 49 | 54.44% | 1.8 |
| Outcome 2 | 35 | 38.89% | 2.6 |
| Outcome 3 | 5 | 5.56% | 18.0 |
| Outcome 4 | 1 | 1.11% | 90.0 |
| Total | 90 | 100.00% | |

The normalization feature of the present invention may be applied to these outcomes, such as illustrated in Table G.

TABLE G

| | | | | | | | Actual |
|---|---|---|---|---|---|---|---|
| | | Tallies | | | Cycle in | Cycle in | Cycle |
| | | Required | New | New | Tallies to | Tallies to | Factoring |
| Options | Weights | for Choice | Weights | Chance | get Choice | get Choice | out Tallies |
| Outcome 1 | 49 | 1 | 49 | 41.18% | 2.4 | 2.4 | 1.8 |
| Outcome 2 | 35 | 1 | 35 | 29.41% | 3.4 | 3.4 | 2.6 |
| Outcome 3 | 5 | 5 | 25 | 21.01% | 4.8 | 23.8 | 18.0 |
| Outcome 4 | 1 | 10 | 10 | 8.40% | 11.9 | 119.0 | 90.0 |

In accordance with the present invention, the requirement that a particular game outcome occur or be selected a number of times before it is presented as a game result has the result of “normalizing” the game. As one example, a game designer may design a slot game so that the result comprising the symbols 777 along a pay line has an associated jackpot winning payout which is desirable to players. Because of the very high payout, however, the game designer may configure the game so that this outcome is weighted less than other outcomes, such as losing outcomes or winning outcomes with lower payouts. However, this weighting does not prevent the 777 outcome from being selected 2, 3 or more times in succession (although the odds may be low). In accordance with the normalization feature described herein, the probability of such an occurrence decreases as the required minimum game count is increased. This increases the probability that the jackpot winning outcomes will be spaced apart by at least a minimum number of games, “spreading” those outcomes apart.

One particular advantage of the invention is that while the normalization feature can be used to impact the statistical probability of a particular game outcome being presented, the feature does not prevent any particular game outcome from being presented as the outcome of any particular game. In particular, even with the normalization feature of the invention employed, any possible game outcome can be selected and presented as the result of each game (e.g. the normalization feature does not eliminate or prevent any particular game outcome from being presented, but instead impacts the probabilities of the presentation of the outcome).

It will be appreciated that the principles of the invention may be applied to any style of game, including wagering games or games presented for entertainment purposes only. In the case of wagering games, the games might comprise slot type games, but might also comprise other types of games such as card games, dice games, roulette type games or various other games.

As indicated above, such games may be presented at casino-style gaming machines or other types of gaming machines, including in on-line or other environments, such as via phones, tablets, computers or the like.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a controller;
at least one electronic video display;
at least one player input device;
machine-readable code executable by said controller to:
a) randomly select a game outcome corresponding to a game to be presented a said gaming machine; and
b) determine if a number of times said game outcome has been selected since the last time said game outcome was presented has reached a minimum value;
if said value has not reached said minimum value, repeating steps a) and b); and
if said minimum value has been reached, causing said electronic video display to display game data representing said selected game outcome.

2. The gaming machine in accordance with claim 1 wherein said number of times is represented by a counter value.

3. The gaming machine in accordance with claim 2 further comprising at least one memory configured to store data representing said counter value.

4. The gaming machine in accordance with claim 2 further comprising incrementing said counter value after said selected of said game outcome.

5. The gaming machine in accordance with claim 2 further comprising resetting said counter value back to a base value if said minimum value has been reached.

6. The gaming machine in accordance with claim 5 wherein said base value comprises zero.

7. The gaming machine in accordance with claim 1 wherein said game has a plurality of possible game outcomes and including a counter corresponding to each of said outcomes.

8. The gaming machine in accordance with claim 7 wherein one or more outcomes may have different minimum values.

9. The gaming machine in accordance with claim 1 wherein said game outcome comprises a slot game outcome comprising a set of slot symbols.

10. A method of presenting a game at a gaming machine comprising the machine-implemented steps of:
a) randomly selecting a game outcome corresponding to a game to be presented a said gaming machine;
b) determining if a number of times said game outcome has been selected since the last time said game outcome was presented has reached a minimum value;
c) if said value has not reached said minimum value, repeating steps a) and b); and
d) if said minimum value has been reached, causing at least one display device of said gaming machine to display game data representing said selected game outcome.

11. The method in accordance with claim 10 further comprising storing a counter value corresponding to said selected game outcome in a memory associated with a processor of said gaming machine.

12. The method in accordance with claim 10 wherein said selected game outcome comprises a winning outcome.

13. The method in accordance with claim 10 wherein said minimum value is greater than one.

14. The method in accordance with claim 10 wherein said number of times is represented by a counter value, said counter value having a base value and comprising the step of incrementing said value when said game outcome is selected and resetting said counter value to said base value when said game outcome is presented.

15. The method in accordance with claim 14 wherein said base value comprises zero and said step of incrementing comprises incrementing said counter value by one.

16. The method in accordance with claim 10 comprising storing a counter value corresponding to each game outcome for said game.

17. The method in accordance with claim 10 comprising storing a counter value corresponding to each winning game outcome for said game.

18. The method in accordance with claim 10 wherein said minimum value may vary for different game outcomes.
